(19) United States
(12) Patent Application Publication
(10) Pub. No.: US 2022/0056776 A1
(43) Pub. Date: Feb. 24, 2022

(54) ASSEMBLY, RETRIEVING DEVICE, AND METHOD FOR RETRIEVING PIPING FROM A WELL

(71) Applicant: SAUDI ARABIAN OIL COMPANY, Dhahran (SA)

(72) Inventor: Nadeer Ahmed Alzayer, Abqaiq (SA)

(73) Assignee: SAUDI ARABIAN OIL COMPANY, Dhahran (SA)

(21) Appl. No.: 16/998,350

(22) Filed: Aug. 20, 2020

(51) Int. Cl. E21B 31/18; F16L 1/032; E21B 47/09

(52) U.S. Cl. CPC E21B 31/18; E21B 47/09; F16L 1/032

(57) ABSTRACT

An assembly for retrieving piping from a well may include a cylindrical housing having a central aperture extending through the cylindrical housing along a central axis thereof. The assembly may include a retrieving device. The retrieving device may include a first securing mechanism having a first cylindrical profile and a first diameter, the first securing mechanism may be configured to axially secure a first type of piping comprising a first outer diameter. The retrieving device may include a second securing mechanism having a second cylindrical profile and a second diameter, the second diameter may be larger than the first diameter and the second. securing mechanism may be configured to axially secure a second type of piping comprising a second outer diameter.

### BACKGROUND

Piping and other materials may become stuck down a wellbore during drilling operations. For example, a drillstring or a bit may break and fall to a bottom of the wellbore. Similarly, a pipe or a tool may fall from a rig floor into the well. This stray equipment is commonly referred to as “fish” or “junk,” and regular drill bits cannot drill through it. In cases where fish or junk may be stuck down the well, especially in the case of piping, retrieving devices may be needed to retrieve the piping. Typically, drilling operations are required to be stopped while the retrieval operation is occurring. Each retrieving device is specially crafted to perform a specific function, or retrieve a certain type of fish, Most retrieving devices are screwed into the end of a fishing string, similar to drillpipe, and lowered into the well in order to perform the fishing operations.

### SUMMARY

In general, in one aspect, embodiments disclosed herein relate to an assembly for retrieving piping from a well. The assembly includes a cylindrical housing having a central aperture extending through the cylindrical housing along a central axis thereof. The assembly includes a retrieving device. The retrieving device includes a first securing mechanism having a first cylindrical profile and a first diameter, the first securing mechanism being configured to axially secure a first type of piping comprising a first outer diameter. The retrieving device includes a second securing mechanism having a second cylindrical profile and a second diameter, the second diameter being larger than the first diameter and the second securing mechanism being configured to axially secure a second type of piping comprising a second outer diameter. The first and the second securing mechanisms are operably connected to be disposed one after another inside the central aperture. The first and the second cylindrical profiles extend in the central aperture for a first combined length shorter than a length of the cylindrical housing. The assembly includes a sealing element mounted on the cylindrical housing, the sealing element being configured to contain the first type or the second type of piping longitudinally. The assembly includes a tool holder operably connected to the retrieving device, the tool holder interfacing the retrieving device with the cylindrical housing. The assembly includes a conveyance mechanism coupled to the cylindrical housing, the conveyance mechanism being configured to transport the cylindrical housing in and out of the well. The retrieving device includes a third securing mechanism having a third cylindrical profile and a third diameter, the third diameter being larger than the second diameter and the third securing mechanism being configured to axially secure a third type of piping comprising a third outer diameter. The first, the second, and the third securing mechanisms are operably connected to be disposed one after another inside the central aperture. The first, the second, and the third cylindrical profiles extend in the central aperture for a second combined length shorter than the length of the cylindrical housing.

In general, in one aspect, embodiments disclosed herein relate to a retrieving device for retrieving piping from a well. The retrieving device includes a first securing mechanism having a first cylindrical profile and a first diameter, the first securing mechanism being configured to axially secure a first type of piping comprising a first outer diameter. The retrieving device includes a second securing mechanism having a second cylindrical profile and a second diameter, the second diameter being larger than the first diameter and the second securing mechanism being configured to axially secure a second type of piping comprising a second outer diameter. The first and the second securing mechanisms are operably connected to be disposed one after another inside a central aperture extending through a cylindrical housing along a central axis thereof. The first and the second cylindrical profiles extend in the central aperture for a first combined length shorter than a length of the cylindrical housing. A sealing element is included mounted on the cylindrical housing, the sealing element being configured to contain the first type or the second type of piping longitudinally. The retrieving device is operably connected to a tool holder, the tool holder interfacing the retrieving device with the cylindrical housing. The cylindrical housing is coupled to a conveyance mechanism, the conveyance mechanism being configured to transport the cylindrical housing in and out of the well. The retrieving device includes a third securing mechanism having a third cylindrical profile and a third diameter, the third diameter being larger than the second diameter and the third securing mechanism being configured to axially secure a third type of piping comprising a third outer diameter. The first, the second, and the third securing mechanisms are operably connected to be disposed one after another inside the central aperture. The first, the second, and the third cylindrical profiles extend in the central aperture for a second combined length shorter than the length of the cylindrical housing.

In general, in one aspect, embodiments disclosed herein relate to a method for retrieving piping from a well. The method includes obtaining a retrieving device. The retrieving device includes a first securing mechanism having a first cylindrical profile and a first diameter, the first securing mechanism being configured to axially secure a first type of piping comprising a first outer diameter. The retrieving device includes a second securing mechanism having a second cylindrical profile and a second diameter, the second diameter being larger than the first diameter and the second securing mechanism being configured to axially secure a second type of piping comprising a second outer diameter. The first and the second securing mechanisms are operably connected to be disposed one after another inside a central aperture extending through a cylindrical housing along a central axis thereof. The first and the second cylindrical profiles extend in the central aperture for a first combined length shorter than a length of the cylindrical housing. A sealing element is included mounted on the cylindrical housing, the sealing element being configured to contain the first type or the second type of piping longitudinally. The retrieving device is operably connected to a tool holder, the tool holder interfacing the retrieving device with the cylindrical housing. The method includes installing the retrieving device in an assembly, the assembly being coupled to a. conveyance mechanism configured to transport the cylindrical housing in and out of the well. The method includes determining a depth of an upper end of the piping. The method includes lowering the assembly down the well to a depth above the depth of the upper end of the piping. The method includes gradually rotating and lowering the conveyance mechanism, the conveyance mechanism causing the assembly to engage the upper end of the piping. The method includes determining whether the assembly is coupled to the upper end of the piping. The method includes determining a robustness of the coupling between the assembly and the upper end of the piping. The method includes collecting the piping from the well by lifting the assembly coupled to the upper end of the piping. The retrieving device includes a third securing mechanism having a third cylindrical profile and a third diameter, the third diameter being larger than the second diameter and the third securing mechanism being configured to axially secure a third type of piping comprising a third outer diameter. The first, the second, and the third securing mechanisms are operably connected to be disposed one after another inside the central aperture. The first, the second, and the third cylindrical profiles extend in the central aperture for a second combined length shorter than the length of the cylindrical housing.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a schematic diagram of an assembly in accordance with one or more embodiments.

FIG. 2 shows a schematic diagram of a system including an assembly in accordance with one or more embodiments.

FIG. 3 shows a schematic diagram of an assembly including a retrieving device in accordance with one or more embodiments.

FIG. 4 shows an exploded view of an assembly including a retrieving device in accordance with one or more embodiments.

FIG. 5 shows a schematic diagram of a retrieving device in accordance with one or more embodiments.

FIG. 6 shows a schematic diagram of a retrieving device in accordance with one or more embodiments.

FIG. 7A shows a schematic diagram of a retrieving device in accordance with one or more embodiments.

FIG. 7B shows a schematic diagram of a retrieving device in accordance with one or more embodiments.

FIG. 7C shows a schematic diagram of a retrieving device in accordance with one or more embodiments.

FIG. 8 shows a schematic diagram of a system including an assembly in accordance with one or more embodiments.

Ha 9 shows a schematic diagram of a system including an assembly in accordance with one or more embodiments.

FIG. 10 shows a schematic diagram of a system including an assembly in accordance with one or more embodiments.

FIG. 11 shows a flowchart in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may he used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include an assembly, a retrieving (i.e., fishing) device and a method for retrieving piping (i.e., cylindrical fish or junk) from a well. In some embodiments, the piping is equipment that has fallen into the well during drilling operations. In some embodiments, the piping is equipment that has been left behind in the well during drilling operations. For example, the piping may be wellbore tubular serrated at a predetermined depth in the wellbore. In some embodiments, a conveyance mechanism translates the assembly in a vertical direction such that the assembly including the retrieving device may be lowered and raised along the wellbore.

In one or more embodiments, the retrieving device increases the chance of retrieving piping from the well by including various securing mechanisms with corresponding piping engagement ranges. The securing mechanisms may include corresponding hardware and/or software configured for engaging a range of piping widths such that each securing mechanism may receive any piping within the range. In some embodiments, the various securing mechanisms may be stacked one after the other inside the assembly. The various securing mechanisms may be stacked in a descending order such that the range of one securing mechanism ends when the range of another securing mechanism starts. In some embodiments, the retrieving device may engage piping with an outer diameter ranging from the widest securing mechanism to the narrowest securing mechanism. In some embodiments, the retrieving device is configured to engage various widths of piping such that a single retrieving device may retrieve various types of piping including their respective widths. As such, the retrieving device may engage the piping on a first attempt.

In some embodiments, the retrieving device engages an upper end of the piping upon lowering the assembly at the predetermined depth where the piping is located. Once the retrieving device engages the piping, the assembly may be raised along with the piping out of the wellbore. In some embodiments, the various securing mechanism may be combined into a single retrieving device. As such, the retrieving device prevents running various retrieving devices with different securing mechanisms, which allows for limited amounts of down-time at a well site.

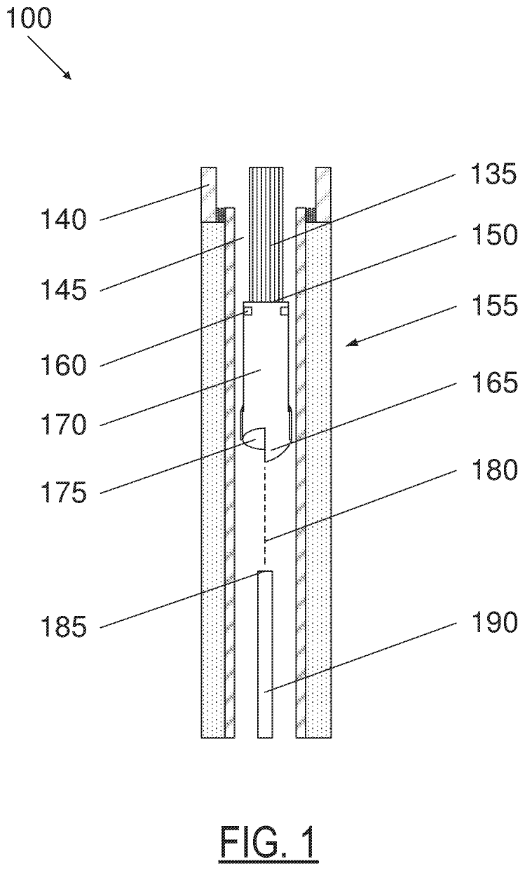

FIG. 1 shows a schematic diagram illustrating an assembly 155 disposed on a cross-section 100 of a wellbore 145. The assembly 155 includes a retrieving device 340 located therewith configured to engage and collect piping 190 (i.e., fish or junk) from the wellbore 145. The assembly 155 has a cylindrical housing 170 with a central aperture 175 that extends through the entire length of the assembly 155 along a central axis 180. As such, the assembly 155 may be a fishing overshot including the retrieving device 340. As an overshot, the assembly 155 may include outside grappling devices fitted with threads or another shape that “swallows” the piping 190 and does not release it as it is pulled out of the well 205.

In some embodiments, the assembly 155 may be attached to a conveyance mechanism 135 at an upper section, which maintains the assembly 155 at a fixed position in the wellbore 145. In some embodiments, the assembly 155 may be installed at a bottom end 150 of the conveyance mechanism 135. In some embodiments, the upper section of the assembly 155 includes one or more ports 160 that may be opened to allow movement of fluids throughout the assembly 155. A guide portion 165 may be the lowermost component of the assembly 155. In some embodiments, the lower section of the assembly 155 may be the guide portion 165 configured to line-up the piping 190 in a vertical direction to overlap the central axis 180. In some embodiments, the guide portion 165 lines-up the piping 190 when a top portion 185 of the piping 190 is closer to a casing 140 of the wellbore 145.

In some embodiments, the piping 190 may have a predetermined width. In one or more embodiments, the piping 190 may have a variable width that is different from the predetermined width. For example, the piping 190 may be piping worn out or broken through by drilling harsh formations or harsh drilling operations. In some embodiments, the assembly 155 may engage the piping 190 using one or more securing mechanisms 420A-420C disposed within the cylindrical housing 170. The assembly 155 prevents running a single size mechanism for a specific piping with a specific outer diameter. In some embodiments, the assembly 155 minimizes tripping times in the wellbore 145 and increases the chances to engage the piping 190 the first time retrieval is attempted. This may help drilling and workover operation saving time and money in case of retrieval being required when including piping uncertain outer diameters are involved.

In some embodiments, the retrieval may be the recovery of the piping 190 or any unwanted material in the wellbore 145. Retrieving operations may he required when items are dropped into the wellbore 145 from a rig floor 260, or after failure of surface equipment and especially pumps, which allow the wellbore 145 to cave in and stick to the drill string. In some embodiments, retrieval may be required after twist-offs resulting from a stuck drill string being rotated until the pipe shears above a sticking point or after loss of portions of downhole equipment into the wellbore 145, such as stabilizer fragments and bit cones.

In some embodiments, the assembly 170 may be an overshot employed to grip the piping 190 from an outside surface to carry it up the wellbore 145. The assembly 170 is used on a contingency basis when drilling a well. The overshot may retrieve an object, called a “fish” or “junk” from the well. This fish, or junk, maybe the piping 190 in the wellbore 145 as a result of a broken down-hole tool, drill pipe, drill bit or an object that has fallen down the well from the surface. These items cause an obstruction for drilling to progress, as the drill bit is not designed to drill out steel objects.

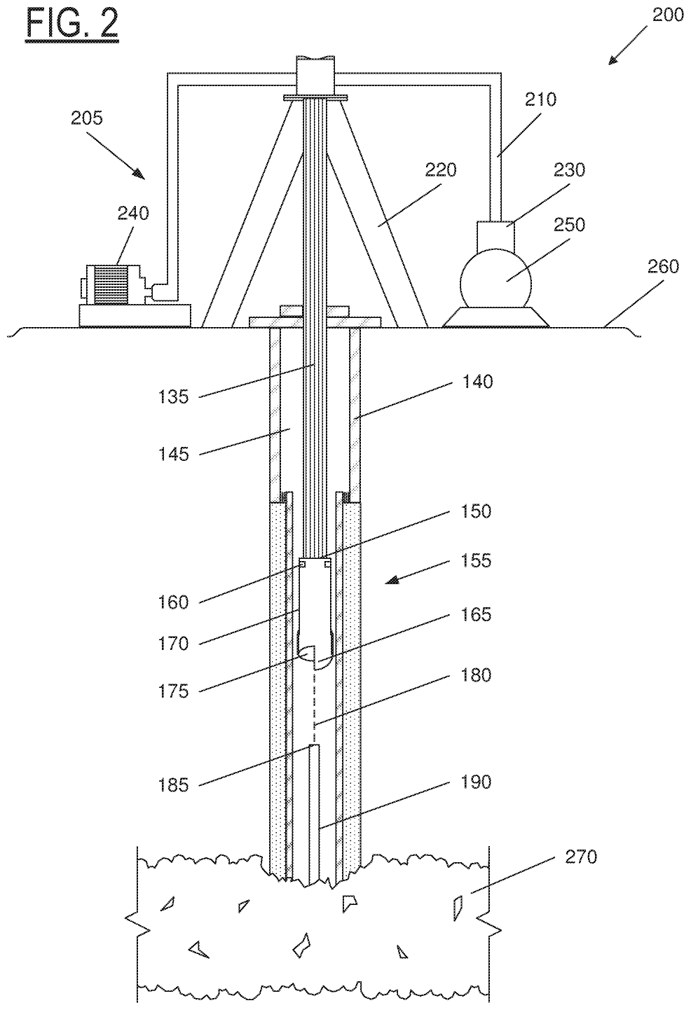

FIG. 2 shows a schematic diagram illustrating the assembly 155 disposed on the wellbore 145 of the well system 200. The well system 200 may include surface equipment including actuating devices 240, sensors 230, and control systems 250 connected to one another using hardware and/or software to create interfaces 210. Further, the well system 200 may be propped by structures 220 from the rig floor 260. The well system 200 includes a wellbore 145 extending from the rig floor 260 to an underground formation 270. The underground formation 270 may have porous areas including hydrocarbon pools that may be accessed through the wellbore 145. In some embodiments, the assembly 155 is translated in a vertical direction along the wellbore 145 using the surface equipment.

The well system 200 includes a well 205 extending below the earth surface into a subsurface formation (“formation”) 270. The formation 270 may include a porous or fractured rock. A subsurface pool of hydrocarbons, such as oil and gas, also known as a reservoir, may be located in the formation 270. The well 205 includes the wellbore 145 that extends from a wellhead at the surface to a target zone in formation 270 the target zone may be where the reservoir (not shown separately) is located. Well 205 may further include casings 140 lining the wellbore 145. In the illustrated example, casings 140 extend into the portion of wellbore 145 penetrating formation 270. In other implementations, the portion of wellbore 145 penetrating formation 270 may be encased or open, and fluid communication between formation 270 and well 205 may occur through an open wall section of the well 205.

The wellbore 145 may facilitate the circulation of drilling fluids during drilling operations. The flow of hydrocarbon production (“production”) (e.g., oil and gas) from the reservoir to the surface during production operations, the injection of substances (e.g., water) into the formation 270 or the during injection operations, or the communication of monitoring devices(e.g., logging tools or logging devices) into the formation 0 or the reservoir during monitoring operations (e.g., during in situ logging operations).

The well system 200 may include a well control system (“control system”) 250. In some embodiments, during operation of the well system 200, the control system 250 may collect and record wellhead data for the well system 200. The control system 25( )may include flow regulating devices that are operable to control the flow of substances into and out of wellbore 145. For example, control system 250 may include one or more production valves (not shown separately) that are operable to control the flow of production in the well system 200 during well completion operations, well maintenance operations, and reservoir monitoring, assessment and development operations. In some embodiments, the control system 250 may regulate the movement of the conveyance mechanism 135 by modifying the power supplied to the actuating devices 240. The conveyance mechanism 135 may be a fishing line or a fishing tool coupling the assembly 155 to the structures 220. The conveyance mechanism 135 may be a special mechanical device used to aid the recovery of equipment lost in the well 205.

In some embodiments, the actuating devices 240 may be motors or pumps connected to the conveyance mechanism 135 and the control system 250. The control system 250 may be coupled to sensors 230 to sense characteristics of substances and conditions in the wellbore 145, including production, passing through or otherwise located in the well system 200. The sensors 230 may include a surface pressure sensor operable to sense the pressure of production flowing to the control system 250, after it exits the wellbore 145. Further, for example, the sensors 230 may include a surface temperature sensor including, for example, a wellhead temperature sensor that senses a temperature of production flowing through or otherwise located in the wellhead, referred to as the “wellhead temperature” (T_{wh}). In some embodiments, for example, the sensors 230 include a flow rate sensor operable to sense the flow rate of production flowing through the control system 250, after it exits the wellbore 145. The flow rate sensor may include hardware that senses the flow rate of production (Q_{wh}) passing through the wellhead.

In some embodiments, the measurements are recorded in real-time, and are available for review or use within seconds, minutes, or hours of the condition being sensed (e.g., the measurements are available within 1 hour of the condition being sensed). In such an embodiment, the wellhead data may be referred to as “real-time” wellhead data. Real-time data may enable an operator of the well system 200 to assess a relatively current state of the well system 200, and make real-time decisions regarding development of the well system 200 and the reservoir, such as on-demand adjustments in regulation of production flow from the well 205.

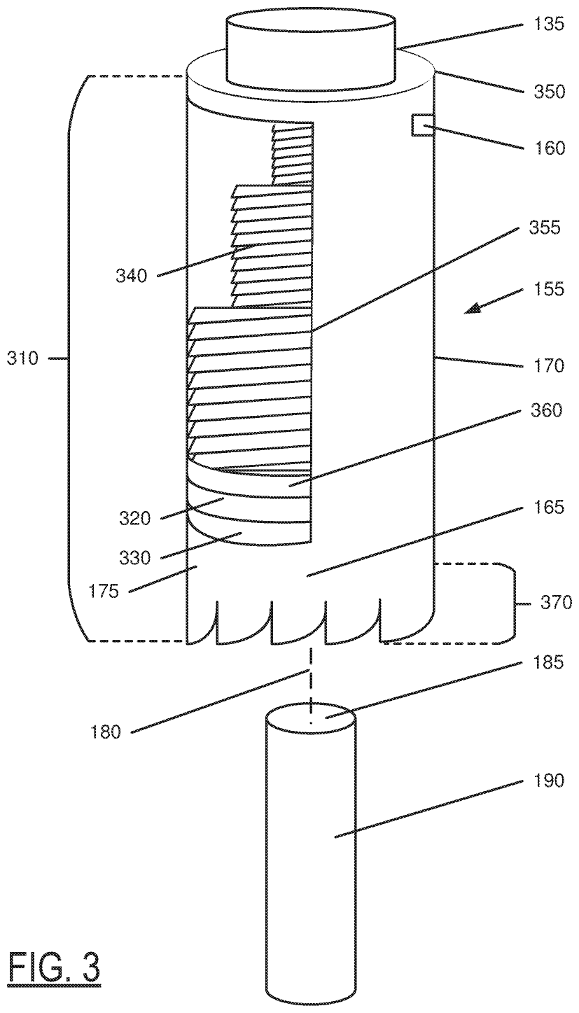

FIG. 3 shows a schematic diagram illustrating the assembly 155 with a cutout 355 which provides a look into the elements disposed inside the cylindrical housing 170. The cylindrical housing 170 extends over a length 310 between a top section 350 and the guide portion 165. The top section 350 may be a coupling surface above the ports 160 including one or more elements for fastening the assembly 155 to the conveyance mechanism 135. The ports 160 may be threaded holes between 1 inch (1″) to 2 inches (2″) in size that may be plugged with bolts or cap inserts that may be opened with a certain pressure. The guide portion 165 may include a guide that may be rotated with the cylindrical housing 170 until the guide portion 165 connects with the top portion 185 of the piping 190. The guide portion 165 may align the piping 190 in the vertical direction until it overlaps the central axis 180. Once the piping is substantially overlapping the central axis 180, the assembly 155 may be lowered to engage the top portion 185 with the retrieving device 340 through the central aperture 175. In some embodiments, the guide portion 165 has a knife saw shape with a corresponding length 370.

In some embodiments, the assembly 155 includes a packer 320, a seal 330, the retrieving device 340, and a control mechanism 360 disposed within the cylindrical housing 170. In some embodiments, the length 310 is proportional to the cumulative lengths the elements disposed within the cylindrical housing 170. A person of ordinary skill in the art will readily observe that the elements disposed within the cylindrical housing 170 may be arranged in a different manner to that shown in FIG.2. Specifically, the seal 330 may be disposed below the packer 320 and the retrieving device 340. Alternatively, the seal 330 and the packer 320 may be located at the bottom portion and the top portion of the cylindrical housing 170, respectively.

The assembly 155 is designed for a maximum piping diameter for the piping 190, which is limited by the central aperture 175. The retrieving device 340 may receive any piping size as long as the outer diameter of the piping 190 is below the maximum piping diameter. A minimum piping diameter of the piping 190 may be designed for a specific retrieving application by modifying the internal diameter of the retrieving device 340.

The packer 320 may be a sealing component that expands inside the retrieving device 340 to fasten the top portion 185 to the seal 330. In some embodiments, the packer 320 includes an internal lip that seals around the outer diameter of the piping 190 once the retrieving device 340 has engaged the piping 190. The packer 320 may be designed to pack-off a specific piping size. The seal 330 may an inner seal, an outer seal, or a combination of both. The seal 330 may prevent junk or fluids from entering or leaving the cylindrical housing 170. The control mechanism 360 may be a grapple control or a mill control packer. Specifically, the control mechanism 360 may transfer torque from the cylindrical housing 170 onto the retrieving device 340.

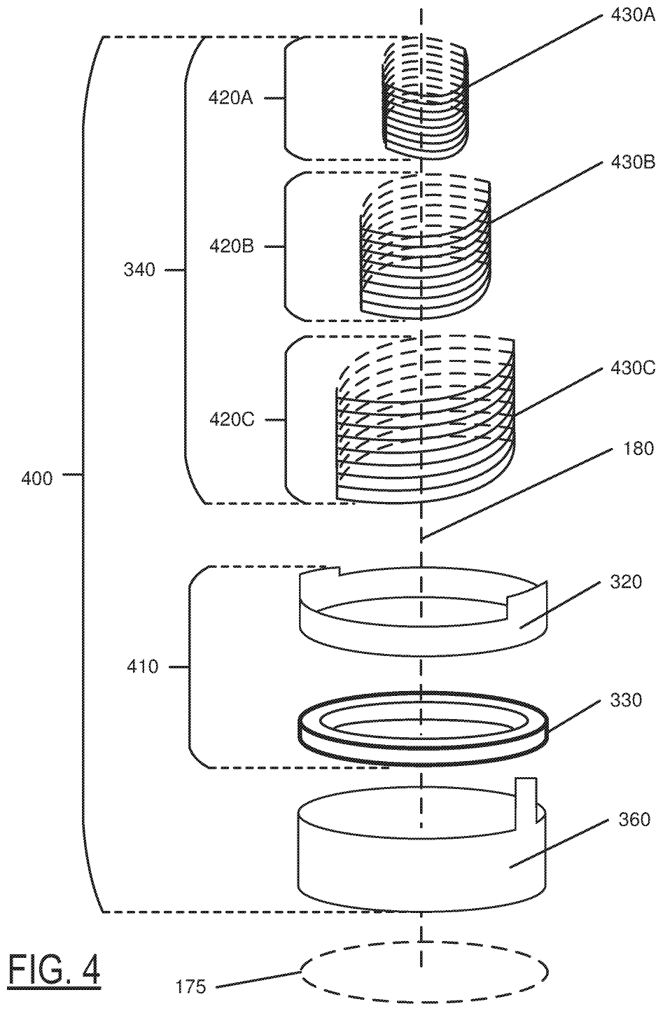

FIG. 4 shows a schematic diagram illustrating an exploded view of the elements disposed within the cylindrical housing 170 of the assembly 155. The elements disposed. within the cylindrical housing 170 may be internal hardware 400 assembled for retrieving the piping 190. The internal hardware may include the packer 320, the seal 330, the retrieving device 340, and the control mechanism 360. In some embodiments, the internal hardware 400 includes a sealing section 410 including the packer 320 and the seal 330. In some embodiments, the retrieving device 340 may include securing mechanisms 430A-430C configured for receiving piping 190 with different outer diameter ranges. In some embodiments, the internal hardware is arranged centered along the central axis 180 and inside the central aperture 175 of the cylindrical housing 155.

The control mechanism 360 may be a grapple control that acts as the transmitted of torque from the cylindrical housing 170 to the retrieving device 340. The control mechanism 360 allow the retrieving device 340 to move vertically inside the bowl during retrieving operations. The control mechanism 360 may be of different types depending on the type of retrieving device 340 that is being implemented. For example, the control mechanism 360 may be a spiral grapple control when the retrieving mechanism 340 is of a spiral grapple type and the control mechanism 360 may be a basket grapple control when the retrieving mechanism 340 is of a basket grapple type. In some embodiments, the control mechanism 360 is a mill control packer when the retrieving mechanism 340 is of a basket grapple type and when the fish requires light dressing prior to engagement. In this case, teeth on the mill control packer (not shown) are designed only to remove small burrs of the piping 190.

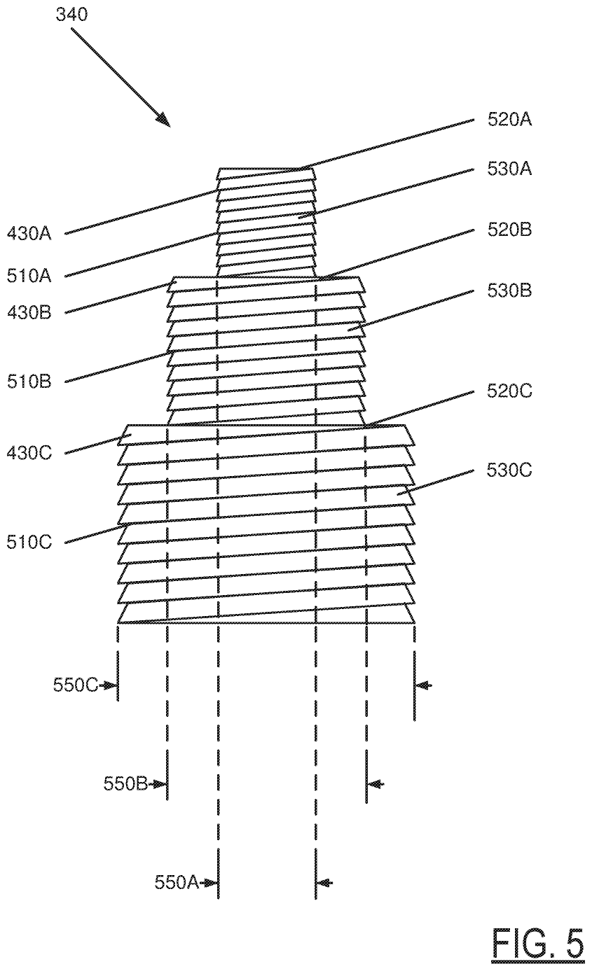

As noted above, the top section 350 may be a top sub at the uppermost end of the assembly 155. The top section 350 may be equipped with a specific box connection (i.e., designed for a specific customer application) that ensures a robust connection between the conveyance mechanism 135 and the cylindrical housing 170. The retrieving device 340 may be a bowl located between the top section 350 and the guide portion 165. The retrieving device 340 may include a range of inside diameters featuring helix sections that conform to the exterior helix of a grapple acting as the securing mechanism of the retrieving device 340. This design permits any expansion or compression strain to be evenly distributed over an entire inner surface of the securing mechanisms 430A-430C of the retrieving device 340. The securing mechanisms 430A-430C have corresponding lengths 420A-420B. The lengths 420A-420C may be equal to one another and may be limited solely by the interior surface of the cylindrical housing 170 and the diameter of the central aperture 175. The securing mechanisms 430A-430C of the retrieving device 340 are explained in detail in FIGS. 5-7C.

FIG. 5 shows a schematic diagram of a retrieving device 340 according to one or more embodiments. The retrieving device 340 is shown including three securing mechanisms 430A-430C of a first type. Each one of the securing mechanisms 430A-430C has a corresponding length 420A-420C and a corresponding diameter 550A-550C. In FIG. 5, the securing mechanisms 430A-430C are arranged one on top of the order in descending order. In this order, the top of the retrieving device 340 includes a first securing mechanism 430A having a first width 550A that is narrower than a second width 550B of a second securing mechanism 430B. Subsequently, the bottom of the retrieving device 340 includes a third securing mechanism 430C having a third width 550C that is wider than the second width 550B of the second securing mechanism 430B. Each one of the securing mechanisms 430A-430C has a corresponding fastening portion 520A-520C on their top end. These fastening portion 520A-520C are connection points for transitioning from one securing mechanism to the other. The fastening portion 520A-520C may be metallic rings connecting the securing mechanisms to one another or to other elements in the cylindrical housing 170.

In FIG. 5, the securing mechanism are shown as having corresponding profiles 510A-510C following corresponding spiral patterns 530A-530C. In this case, the securing mechanisms 430A-430C may be spiral grapples having a left-handed helix shape. These securing mechanisms 430A-430C have hardened interior wickers in a grapple to ensure positive (i.e., inward and downward) engagement with the piping 190.

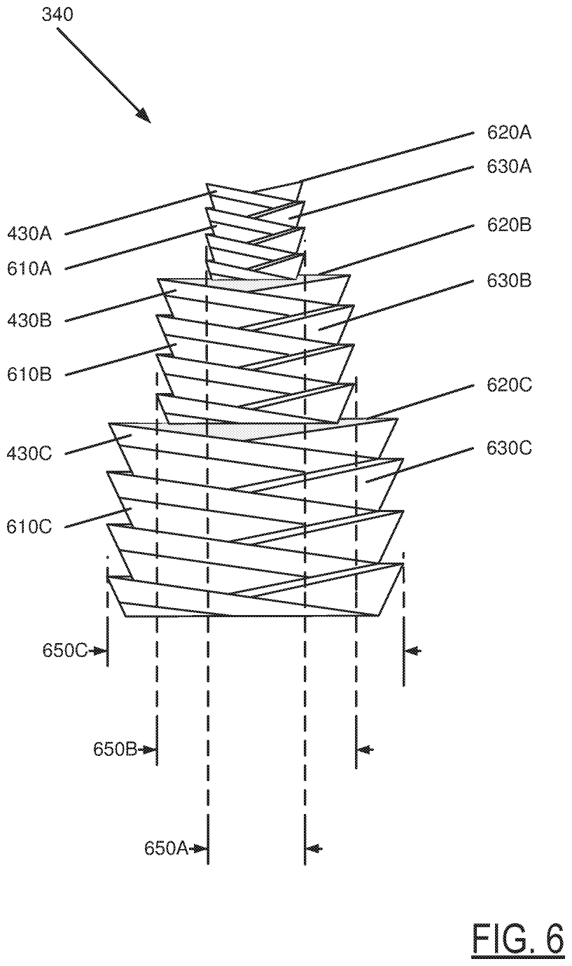

FIG. 6 shows a schematic diagram of a retrieving device 340 according to one or more embodiments. The retrieving device 340 is shown including three securing mechanisms 430A-430C of a second type. Each one of the securing mechanisms 430A-430C has a corresponding length 420A-420C and a corresponding diameter 650A650C. In FIG. 6, the securing mechanisms 430A-430C are arranged one on top of the order in descending order similar to those described in FIG. 5. In this order, the top of the retrieving device 340 includes a first securing mechanism 430A having a first width 650A that is narrower than a second width 650B of a second securing mechanism 430B. Subsequently, the bottom of the retrieving device 340 includes a third securing mechanism 430C having a third width 650C that is wider than the second width 650B of the second securing mechanism 430B. Each one of the securing mechanisms 430A-430C has a corresponding fastening portion 620A-620C on their top end. These fastening portion 620A-620C are connection points for transitioning from one securing mechanism to the other. The fastening portion 620A-620C may be metallic rings connecting the securing mechanisms to one another or to other elements in the cylindrical housing 170.

In FIG. 6, the securing mechanism are shown as having corresponding profiles 610A-610C following corresponding spiral patterns 630A-630C. In this case, the securing mechanisms 430A-430C may be basket grapples having slotted, expandable cylinders with wickers in interior surfaces to engage piping with different outer diameters. The tapered exteriors conform to the interior of the securing mechanisms 430A-430C. To meet the needs of various retrieval operations, three types of basket grapples may be implemented: plain (standard), short-catch stop, and long-catch stop. The plain basket grapple may be used when a milling operation has preceded the retrieval operation. This type of basket grapple is used to retrieve piping with a uniform outside diameter. During fishing operations, piping passes completely through the securing mechanisms 430A-430C. Wickers running the entire interior lengths 420A-420C of the securing mechanisms 430A-430C securely grip piping.

In FIGS. 5 and 6, the securing mechanisms 430A-430C of the retrieving device 340 are tapered catch mechanisms to retrieve piping of different outer diameter sizes in a single retrieving operation. An inner surface of the retrieving device 340 is tapered to allow the tapered spiral grapple or the tapered basket grapple with specific retrieval outer diameter size ranges. For example, an assembly 155 with a central aperture 175 of 5⅝″ may be designed for retrieving piping with outer diameters between 4¾″ and 4¼″, In this case, having at least three securing mechanisms 430A-430C may retrieve piping with outer diameter sizes of around 4¾″, 4½″, and 4¼″, respectively. The corresponding lengths 420A-420C may be between 6″ and 10″ to hold piping within the aforementioned range. In another example, an assembly 155 with a central aperture 175 of 5⅝″ may be designed for retrieving piping with outer diameters between 4½″ and 4″. In this case, having at least three securing mechanisms 430A-430C may retrieve piping with outer diameter sizes of around 4½″, 4¼″, and 4″, respectively. The corresponding lengths 420A-420C may be between 4″ and 8″ to hold piping within the aforementioned range. In some embodiments, the retrieving device 340 may be modified to change the diameters of the securing mechanisms 430A-430C along with their respective lengths 420A-420C.

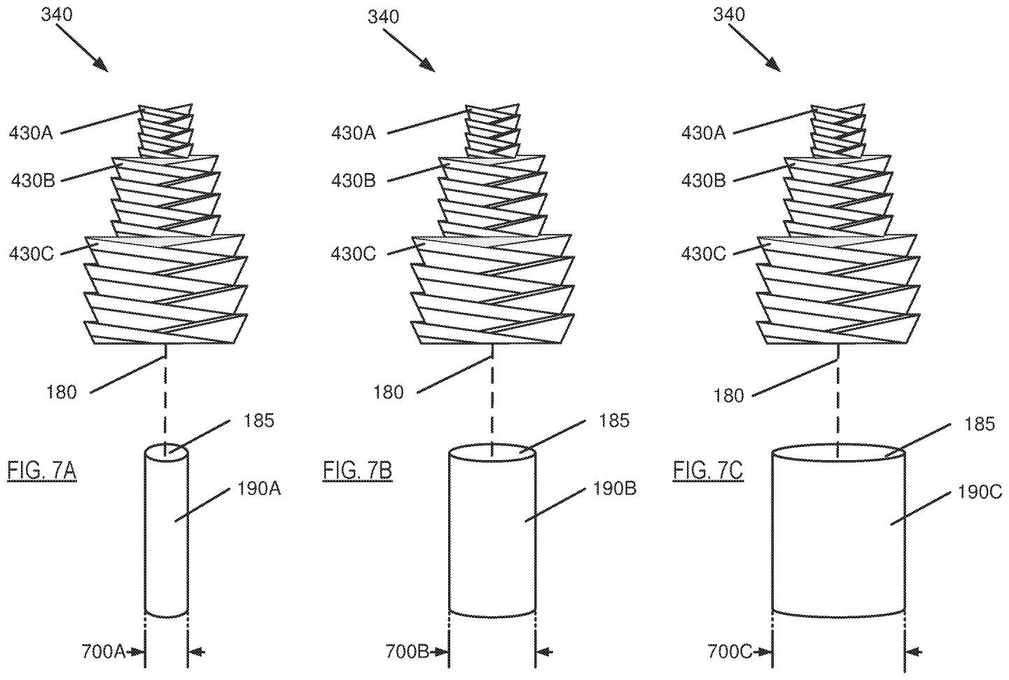

FIGS. 7A, 7B, and 7C show schematic diagrams illustrating piping 190A-190C of different outer diameters 700A-700C. As described above, the retrieving device 340 may include securing mechanisms 430A-430C configured to engage outer diameters 700A-700C of the corresponding piping 190A-190C. In this regard, the same retrieving device 340 may engage all of piping 190A-190C. Specifically, a first piping 190A may be engaged by the first securing mechanism 430A, a second piping 190B may be engaged by the second securing mechanism 430B, and a third piping 190c may be engaged by the third securing mechanism 430C.

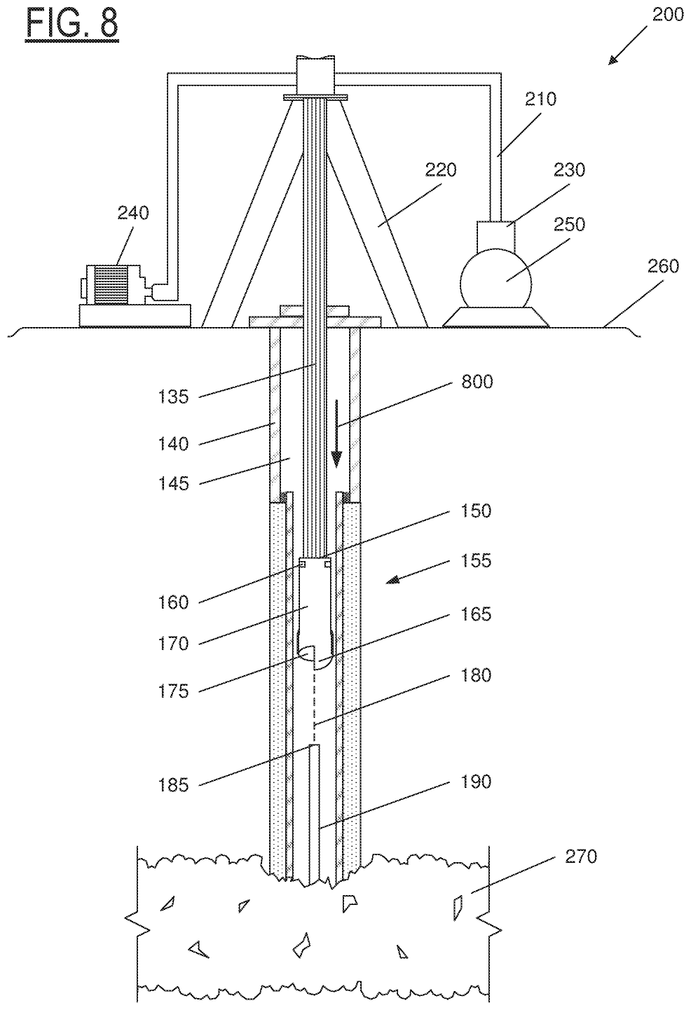

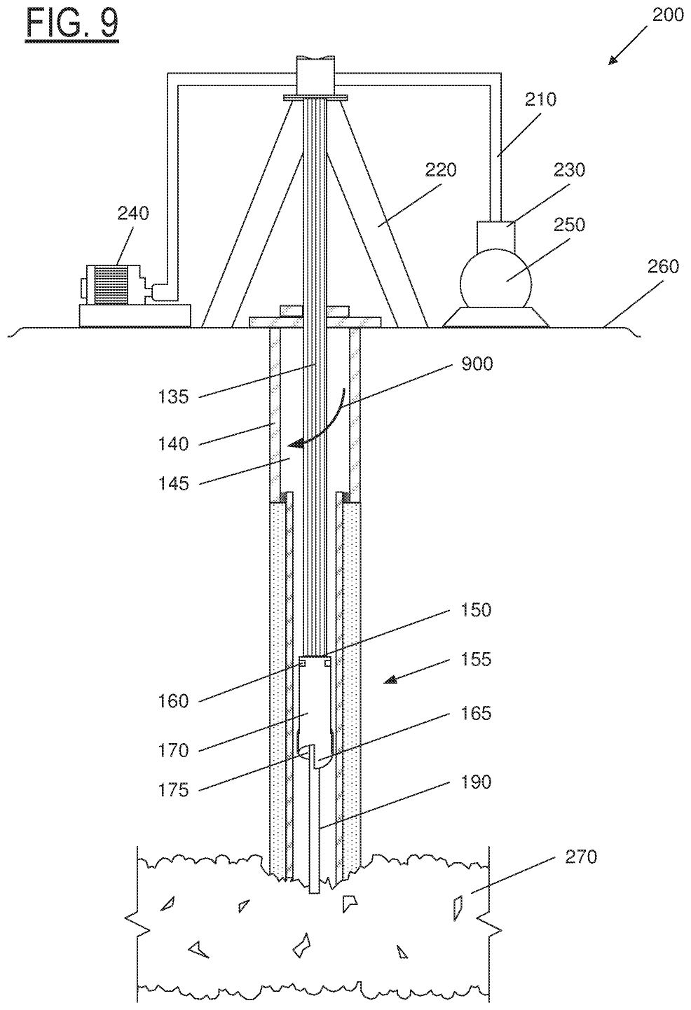

FIG. 8 shows an example of the assembly 155 being lowered into the wellbore 140 to retrieve the piping 190. In some embodiments, the assembly 155 is lowered into the wellbore 140 using the conveyance mechanism 135 rolled from rig floor 260 of the well 205 in a downward direction 800. In some embodiments, the conveyance mechanism 120 is rolled by the actuating devices 240 coupled to the structures 220. The actuating devices 240 and the structures 220 operate to lower or raise the conveyance mechanism 135. In this case, the actuating devices 240 and the structures 220 are used for lowering the assembly 155 into a depth above a depth of the top portion 185 of the piping 190. In some embodiments, the interfaces 210 includes controls for monitoring and operating the movement of the conveyance mechanism 135 using a hydraulic pump (not shown).

FIG. 9 illustrates an example of the assembly 155 engaging the piping 190. The assembly 155 is lowered onto the top portion 185 of the piping 190 following a clockwise direction 900. In this case, the retrieving device 340 in the assembly 155 engages the piping 190. The retrieving device 340 engages the piping 190 by attaching one of the securing mechanisms 430A-430B around the outer diameter of the piping 190 using friction. Specifically, when the assembly 155 reaches the top portion 185 of the piping 190, combined rotation and lowering results in directing the piping 190 into the central aperture 175 and the bottom of the retrieving device 340 and expanding the retrieving device 340 until the piping 190 reaches a top end of the securing mechanism being engaged.

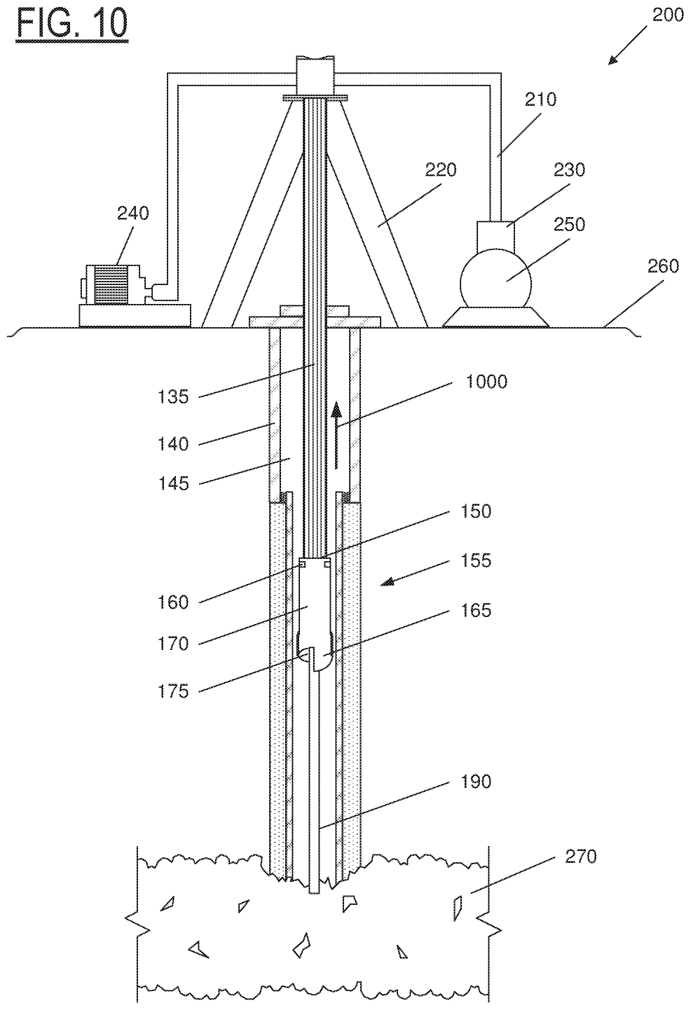

FIG. 10 shows an example of the assembly 155 lifting the piping 19 along the wellbore 140 in an upward direction 1000. The assembly 155 is lifted along the piping 190 using the conveyance mechanism 135. The conveyance mechanism 135 is lifted in a straight direction while avoiding any rotation of the assembly 155. The piping 190 is released upon reaching a height above the rig floor 260.

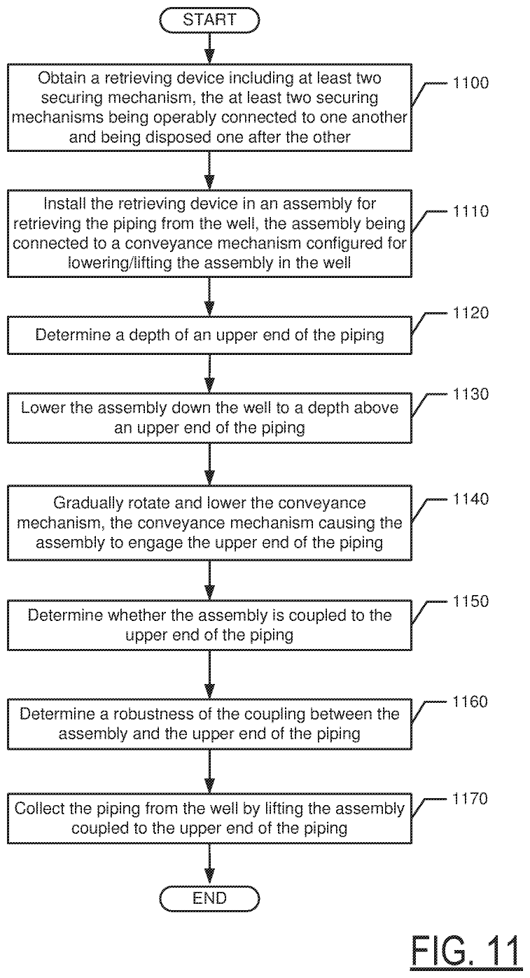

FIG. 11 shows a flowchart in accordance with one or more embodiments. Specifically, FIG. 11 describes a method for retrieving piping from the well 205 using the control system 250 described in reference to FIGS. 2 and 8-10. Further, one or more blocks in FIG. 11. may be performed by one or more components as described in FIGS. 8-10 (e.g., actuating devices 240 coupled to the conveyance mechanism 135 and the control system 250). While the various blocks in FIG. 11 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 1100, the retrieving device 340 is obtained before starting retrieval operations. The retrieving device 340 includes at least two securing mechanisms of the securing mechanisms 430A-430C. The control system 250 calculates at least two securing mechanisms that provide a range of possible outer diameters for the piping 190. As explained above, the securing mechanisms are arranged one on top of the other to allow the range of engaging outer diameters of the piping 190 to fit on either of the securing mechanisms.

In Block 1110, the retrieving device 340 is installed in the assembly 155 for retrieving the piping 190 from the well 205. The installation is performed using adhesives, fastening elements, or threads as part of an upper assembling of the assembly 155. Installation may be performed while including the assembly 155 on the conveyance mechanism 135. As described above, the conveyance mechanism 135 is configured for lowering/lifting the assembly 155 in the well 205.

In Block 1120, the computer system 250 calculates the depth at which the top portion 185 of the piping 190 is located. In some embodiments, the depth of the top portion 185 may be a depth of an upper end of the piping 190. The depth of the top portion 185 may be a predetermined depth or a depth calculated based on sensory feedback collected by the sensors 230.

In Block 1130, the assembly 155 is lowered in the downward direction 800 along the well 205 to the depth above the upper end of the piping 190. In some embodiments, the control systems 250 determine this depth based on the depth calculated in block 1130.

In Block 1140, the conveyance mechanism 135 is rotated and lowered in the clockwise direction 900 simultaneously so that the piping 190 may enter the central aperture 175 in a position overlapping the central axis 180. At this point, the piping 190 starts engaging one of the securing mechanisms 430A-430C of the retrieving device 340.

In Block 1150, the control system 250 determines whether the assembly 155 is coupled to the upper end of the piping 190. At this point, the control system 250 may measure the pressure in the assembly 155 to identify whether the piping 190 has been fully engaged by the retrieving device 340. In some embodiments, the control system 250 may identify the weight of the conveyance system 135 to determine whether the piping 190 may be lifted.

In Block 1160, the control system 250 determines a robustness of the coupling established between the assembly 155 and the upper end of the piping 190. At this point, the control system 250 may use one of the sensors 230 to determine whether the coupling of the piping 190 and the retrieving device 340 is robust enough to hold the piping 190 during the remaining of the retrieval operation.

In Block 1170, the piping 190 is collected from the well 205 by lifting the assembly 155 coupled to the upper end of the piping 190 in an upward direction 1000. At this point, the piping 190 is lifted at a steady speed while maintaining the coupled connection with the retrieving device 340. Once the piping 190 reaches a predetermined height above the rig surface 360, the piping 190 may be released by rotating the conveyance mechanism 135 in a counter-clockwise direction (not shown). As an example, a possible predetermined height may be a height equal to a length of the piping 190 such that the piping 190 may be disengaged from the retrieving device 340 when an entirety of the piping 190 leaves the wellbore 140.

As noted above the method described in Blocks 1100-1170 reduces the nonproductive time in retrieval or fishing operations for an oil field. Specifically, the method results in saving cost when a drill pipe breaks down or a tool gets stuck in the wellbore 140. In this regard, the method eliminates the need for performing multiple retrieval operations when the conditions down the wellbore are not well known. Similarly, the method eliminates the need for performing multiple retrieval operations when the outside diameter of the piping 190 is not previously known.

While FIGS. 1-11 show various configurations of components, other configurations may be used without departing from the scope of the disclosure. For example, various components in FIGS. 2 and 8-10 may be combined to create a single component. As another example, the functionality performed by a single component may be performed by two or more components.

While the disclosure has been described with respect to a limited number of embodiments, those skilled in the art, having benefit of this disclosure, will appreciate that other embodiments can be devised which do not depart from the scope of the disclosure as disclosed. herein. Accordingly, the scope of the disclosure should be limited. only by the attached claims.

1. An assembly for retrieving piping from a well, the assembly comprising:
a cylindrical housing having a central aperture extending through the cylindrical housing along a central axis thereof;
a retrieving device comprising:
a first securing mechanism having a first cylindrical profile and a first diameter, the first securing mechanism being configured to axially secure a first type of piping comprising a first outer diameter,
a second securing mechanism having a second cylindrical profile and a second diameter, the second diameter being larger than the first diameter and the second securing mechanism being configured to axially secure a second type of piping comprising a second outer diameter,
wherein the first and the second securing mechanisms are operably connected together via corresponding fastening portions at top ends of the first and the second securing mechanisms to be disposed one after another inside the central aperture, and
wherein the first and the second cylindrical profiles extend in the central aperture for a first combined length shorter than a length of the cylindrical housing;
a sealing element mounted on the cylindrical housing, the sealing element being configured to contain the first type or the second type of piping longitudinally;
a tool holder operably connected to the retrieving device, the tool holder interfacing the retrieving device with the cylindrical housing; and
a conveyance mechanism coupled to the cylindrical housing, the conveyance mechanism being configured to transport the cylindrical housing in and out of the well.

2. The assembly according to claim 1,
wherein the retrieving device further comprises:
a third securing mechanism having a third cylindrical profile and a third diameter, the third diameter being larger than the second diameter and the third securing mechanism being configured to axially secure a third type of piping comprising a third outer diameter,
wherein the first, the second, and the third securing mechanisms are operably connected together via the corresponding fastening portions at the top ends of the first, the second, and the third securing mechanisms to be disposed one after another inside the central aperture, and
wherein the first, the second, and the third cylindrical profiles extend in the central aperture for a second combined length shorter than the length of the cylindrical housing.

3. The assembly according to claim 2,
wherein at least one of the first, the second, and the third cylindrical profiles are a first type of cylindrical profile, the first type of cylindrical profile being formed as an expandable cylinder with a tapered exterior.

4. The assembly according to claim 2,
wherein at least one of the first, the second, and the third cylindrical profiles are a first type of cylindrical profile, the first type of cylindrical profile being formed as a left-hand helix with a tapered exterior.

5. The assembly according to claim 1,
wherein the cylindrical housing further comprises:
a pair of plugged threaded ports that seal an upper section of the cylindrical housing.

6. The assembly according to claim 2,
wherein the cylindrical housing further comprises:
a guide portion configured to capture at least one of the first, second, and the third type of piping upon rotation of the cylindrical housing.

7. The assembly according to claim 2,
wherein the cylindrical housing further comprises:
a guide portion located at a lower section of the cylindrical housing, the guide portion comprising a knife saw shape configured to clear debris on an outside surface of at least one of the first, second, and the third type of piping upon rotation of the cylindrical housing.

8. A retrieving device for retrieving piping from a well, the device comprising:
a first securing mechanism having a first cylindrical profile and a first diameter, the first securing mechanism being configured to axially secure a first type of piping comprising a first outer diameter; and
a second securing mechanism having a second cylindrical profile and a second diameter, the second diameter being larger than the first diameter and the second securing mechanism being configured to axially secure a second type of piping comprising a second outer diameter,
wherein the first and the second securing mechanisms are operably connected together via corresponding fastening portions at top ends of the first and the second securing mechanisms to be disposed one after another inside a central aperture extending through a cylindrical housing along a central axis thereof,
wherein the first and the second cylindrical profiles extend in the central aperture for a first combined length shorter than a length of the cylindrical housing,
wherein a sealing element mounted on the cylindrical housing, the sealing element being configured to contain the first type or the second type of piping longitudinally,
wherein the retrieving device is operably connected to a tool holder, the tool holder interfacing the retrieving device with the cylindrical housing, and
wherein the cylindrical housing is coupled to a conveyance mechanism, the conveyance mechanism being configured to transport the cylindrical housing in and out of the well.

9. The device according to claim 8,
wherein the retrieving device further comprises:
a third securing mechanism having a third cylindrical profile and a third diameter, the third diameter being larger than the second diameter and the third securing mechanism being configured to axially secure a third type of piping comprising a third outer diameter,
wherein the first, the second, and the third securing mechanisms are operably connected together via the corresponding fastening portions at the top ends of the first, the second, and the third securing mechanisms to be disposed one after another inside the central aperture, and
wherein the first, the second, and the third cylindrical profiles extend in the central aperture for a second combined length shorter than the length of the cylindrical housing.

10. The device according to claim 9,
wherein at least one of the first, the second, and the third cylindrical profiles are a first type of cylindrical profile, the first type of cylindrical profile being formed as an expandable cylinder with a tapered exterior.

11. The device according to claim 9,
wherein at least one of the first, the second, and the third cylindrical profiles are a first type of cylindrical profile, the first type of cylindrical profile being formed as a left-hand helix with a tapered exterior.

12. The device according to claim 8,
wherein the cylindrical housing further comprises:
a pair of plugged threaded ports that seal an upper section of the cylindrical housing.

13. The device according to claim 9,
wherein the cylindrical housing further comprises:
a guide portion configured to capture at least one of the first, second, and the third type of piping upon rotation of the cylindrical housing.

14. The device according to claim 9,
wherein the cylindrical housing further comprises:
a guide portion located at a lower section of the cylindrical housing, the guide portion comprising a knife saw shape configured to clear debris on an outside surface of at least one of the first, second, and the third type of piping upon rotation of the cylindrical housing.

15. A method for retrieving piping from a well, the method comprising:
obtaining a retrieving device, the retrieving device comprising:
a first securing mechanism having a first cylindrical profile and a first diameter, the first securing mechanism being configured to axially secure a first type of piping comprising a first outer diameter,
a second securing mechanism having a second cylindrical profile and a second diameter, the second diameter being larger than the first diameter and the second securing mechanism being configured to axially secure a second type of piping comprising a second outer diameter,
wherein the first and the second securing mechanisms are operably connected together via corresponding fastening portions at top ends of the first and the second securing mechanisms to be disposed one after another inside a central aperture extending through a cylindrical housing along a central axis thereof, and
wherein the first and the second cylindrical profiles extend in the central aperture for a first combined length shorter than a length of the cylindrical housing,
wherein a sealing element mounted on the cylindrical housing, the sealing element being configured to contain the first type or the second type of piping longitudinally, and
wherein the retrieving device is operably connected to a tool holder, the tool holder interfacing the retrieving device with the cylindrical housing;
installing the retrieving device in an assembly, the assembly being coupled to a conveyance mechanism configured to transport the cylindrical housing in and out of the well;
determining a depth of an upper end of the piping;
lowering the assembly down the well to a depth above the depth of the upper end of the piping;
gradually rotating and lowering the conveyance mechanism, the conveyance mechanism causing the assembly to engage the upper end of the piping;
determining whether the assembly is coupled to the upper end of the piping;
determining a robustness of the coupling between the assembly and the upper end of the piping; and
collecting the piping from the well by lifting the assembly coupled to the upper end of the piping.

16. The method according to claim 15,
wherein the retrieving device further comprises:
a third securing mechanism having a third cylindrical profile and a third diameter, the third diameter being larger than the second diameter and the third securing mechanism being configured to axially secure a third type of piping comprising a third outer diameter,
wherein the first, the second, and the third securing mechanisms are operably connected together via the corresponding fastening portions at the top ends of the first, the second, and the third securing mechanisms to be disposed one after another inside the central aperture, and
wherein the first, the second, and the third cylindrical profiles extend in the central aperture for a second combined length shorter than the length of the cylindrical housing.

17. The method according to claim 16,
wherein at least one of the first, the second, and the third cylindrical profiles are a first type of cylindrical profile, the first type of cylindrical profile being formed as an expandable cylinder with a tapered exterior.

18. The method according to claim 16,
wherein at least one of the first, the second, and the third cylindrical profiles are a first type of cylindrical profile, the first type of cylindrical profile being formed as a left-hand helix with a tapered exterior.

19. The method according to claim 16,
wherein the cylindrical housing further comprises:
a guide portion configured to capture at least one of the first, second, and the third type of piping upon rotation of the cylindrical housing.

20. The method according to claim 16,
wherein the cylindrical housing further comprises:
a guide portion located at a lower section of the cylindrical housing, the guide portion comprising a knife saw shape configured to clear debris on an outside surface of at least one of the first, second, and the third type of piping upon rotation of the cylindrical housing.
